(19) United States
(12) Patent Application Publication
(10) Pub. No.: US 2002/0167145 A1
(43) Pub. Date: Nov. 14, 2002

(54) Toy scooter gyration force axle assembly structure

(76) Inventor: Chun-Huo Lin, Chang-Hua Hsien (TW)

Correspondence Address: Dougherty & Troxell, ONE SKYLINE PLACE, SUITE1404, 5205 LEESBURG PIKE, FALLS CHURCH, VA, 22041, US

(21) Appl. No.: 09/852,639

(22) Filed: May 11, 2001

(51) Int. Cl. B62M 1/00; A63H 17/00

(52) U.S. Cl. 280/87.041; 446/465

(57) ABSTRACT

A scooter structure having both decorative and toy performance that is comprised of a scooter body and a gyration force gear unit fastened to the lower end of the body. The body has a lateral retaining edge extending downward from each of the two sides of its bottom end and, furthermore, an access opening is formed in the lateral retaining edge to accommodate the insertion and positioning of the gyration force gear unit. A mortise is formed in each of the two sides of the holding section of a carrier mount such that a corresponding tenon formed on each of the two sides of the gyration force mount can be inserted and positioned. Turning wheels at the two sides of the gyration force mount are positionally fixed over the holding section and, furthermore, a space is left between each turning wheel and lateral end of the holding section that prevents the lock-up of the gyration force mount and the carrier mount during the execution of turns that would adversely affect the coasting of the toy scooter. As such, the present invention provides the user a toy scooter gyration force axle assembly structure having both decorative profiling and toy performance.

### BACKGROUND OF THE INVENTION

1) Field of the Invention

The invention herein relates to a toy scooter gyration force axle assembly structure, the structural features of which includes a body having a lateral retaining edge extending downward from each of the two sides of its bottom end and, furthermore, an access opening formed in the lateral retaining edge to accommodate the insertion and positioning of the gyration force gear unit as well as the carrier mount of the gyration force gear unit consisting of a gyration force mount that is inserted into its holding section, enabling the turning wheels at the two sides of the gyration force mount to be positionally fixed over the holding section and, furthermore, with a space left between each turning wheel and lateral end of the holding section that prevents the lock-up of the gyration force mount and the carrier mount during the execution of turns that would adversely affect the coasting of the toy scooter; as such, the present invention achieves both decorative profiling and toy performance.

2) Description of the Prior Art

Conventional gyration force toy vehicles lack shaping capability as a major feature; if so equipped, it is only ornamentation installed on the exterior of a scooter that is merely a simple embellishment incapable of providing users a satisfying range of options; in view of this, the inventor of the invention herein conducted research and completed the present invention, the structure of which provides the user both amusement and options.

### SUMMARY OF THE INVENTION

The primary objective of the invention herein is to provide a toy scooter gyration force axle assembly structure, wherein the said body has a lateral retaining edge extending downward from each of the two sides of its bottom end and, furthermore, an access opening is formed in the lateral retaining edge to accommodate the insertion and positioning of the gyration force gear unit; a mortise is formed in each of the two sides of the holding section of a carrier mount such that a corresponding tenon formed on each of the two sides of the gyration force mount can be inserted and positioned; turning wheels at the two sides of the gyration force mount are positionally fixed over the holding section and, furthermore, a space is left between each turning wheel and lateral end of the holding section that prevents the lock-up of the gyration force mount and the carrier mount during the execution of turns that would adversely affect the coasting of the toy scooter; as such, the present invention provides the user a toy scooter gyration force axle assembly structure having both decorative profiling and toy performance.

To enable the examination committee a further understanding of the structure, innovative features, performance, and practical objectives of the present invention, the brief description of the drawings below is followed by the detailed description of the invention herein.

### BRIEF DESCRIPTION OF THE DRAWINGS

FIG. 1 is an exploded drawing of the invention herein.

FIG. 2 is an isometric drawing of the invention herein.

FIG. 3 is a cross-sectional drawing of the invention herein.

FIG. 4-A is an isometric drawing before the gyration force mount is coupled to the carrier mount.

FIG. 4-B is an isometric drawing as the gyration force mount is installed onto the carrier mount.

FIG. 4-C in an isometric drawing after the gyration force mount is installed onto the carrier mount.

FIG. 5 is an orthographic drawing of the invention herein, as viewed from the top.

### DETAILED DESCRIPTION OF THE INVENTION

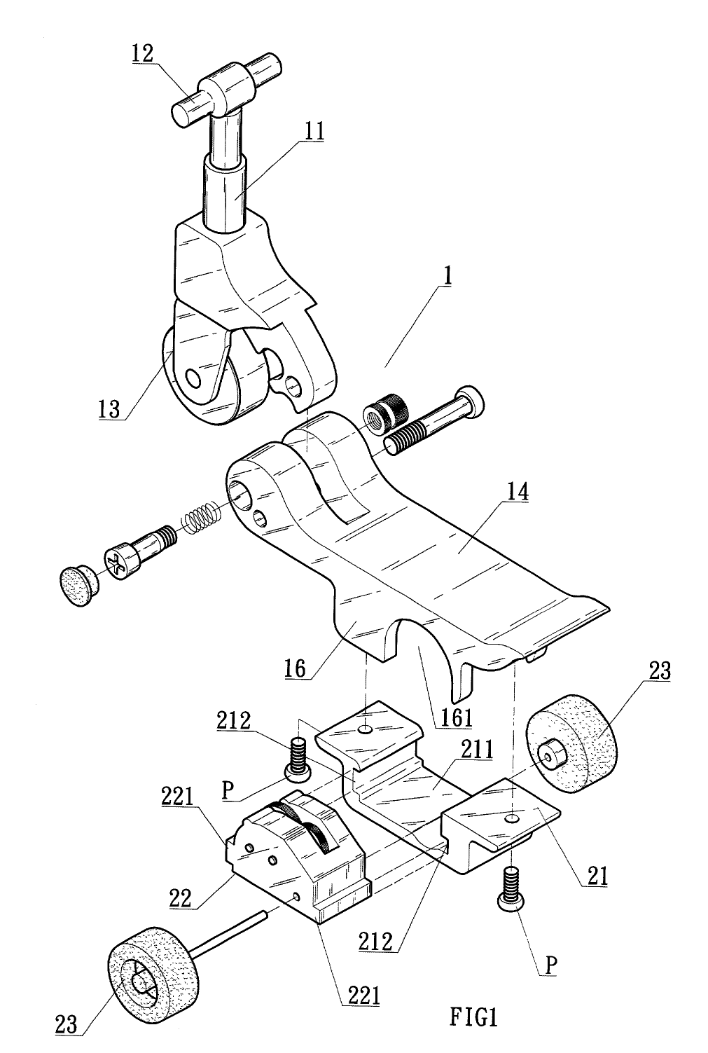

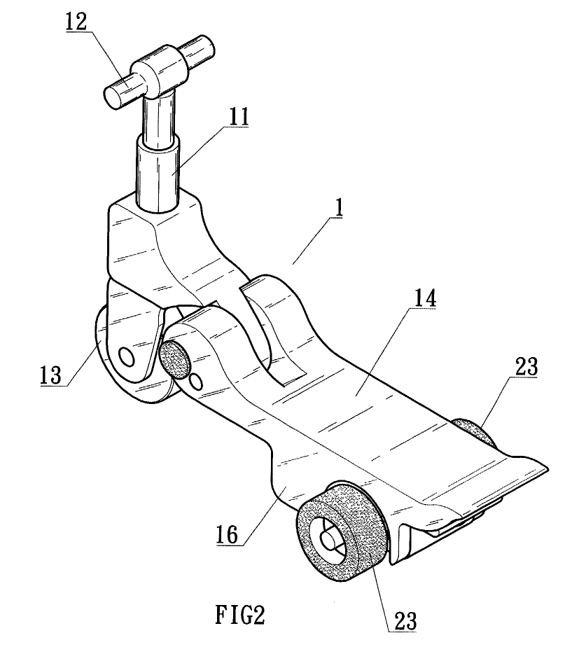

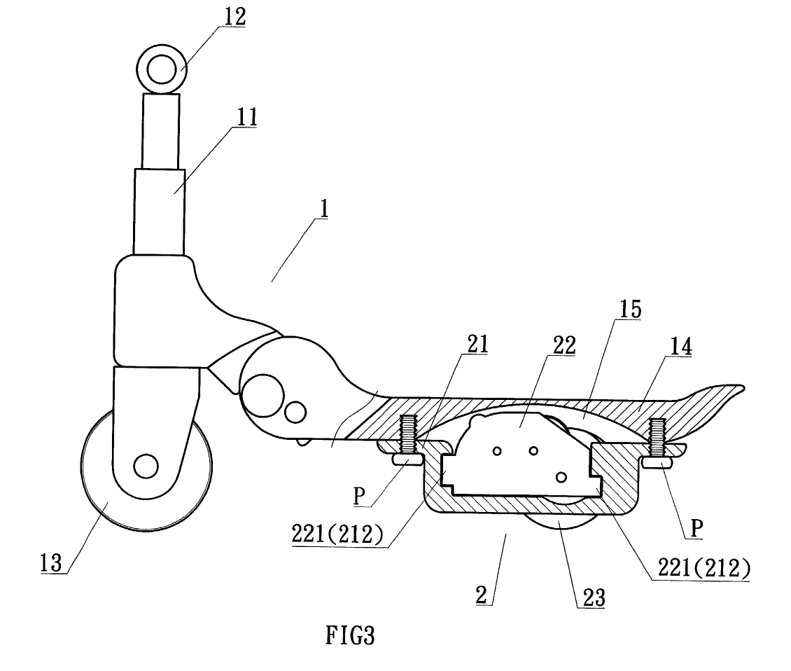

Referring to FIG. 1, FIG. 2, and FIG. 3, the structural arrangement of the present invention, the invention herein is comprised of a scooter body 1 and a gyration force gear unit 2 fastened to the lower end of the body 1 by bolts P, of which:

The said body 1 consists of a front fork stem 11 having a handle bar 12 extending horizontally from its upper extent and, furthermore, a front wheel 13 installed at the bottom end of the front fork stem 11, with the projecting portion of the front fork stem 11 conjoined to a scooter chassis 14; a locating vault 15 of a moderately concave contour is formed in the bottom surface of the body 1 chassis 14 to limit the forward and rearward movement of the gyration force gear unit 2; a lateral retaining edge 16 extends downward from each of the two sides at the bottom end of the body 1 to limit the leftward and rightward movement of the gyration force gear unit 2 and, furthermore, an access opening 161 is formed in the lateral retaining edge 16 to accommodate the insertion and positioning of the gyration force gear unit 2.

The said gyration force gear unit 2 consists of a carrier mount 21 that is fastened to the lower extent of the body 1 chassis 14 and a gyration force mount 22 that is inserted into the carrier mount 21; a holding section 211 is disposed as a recess in the center portion, and, furthermore, a mortise 212 is formed in each of the two sides of the holding section 211 such that a corresponding tenon 221 formed on each of the two sides of the gyration force mount 22 can be inserted and positioned.

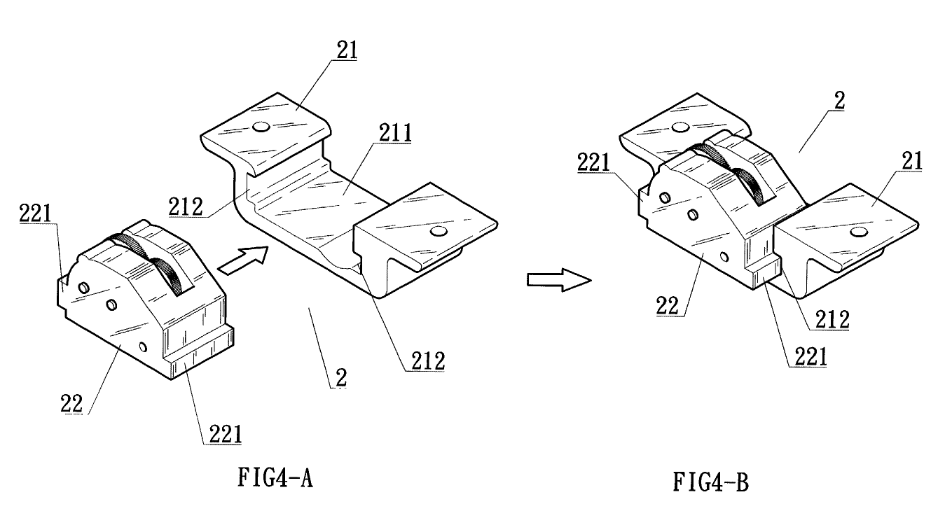

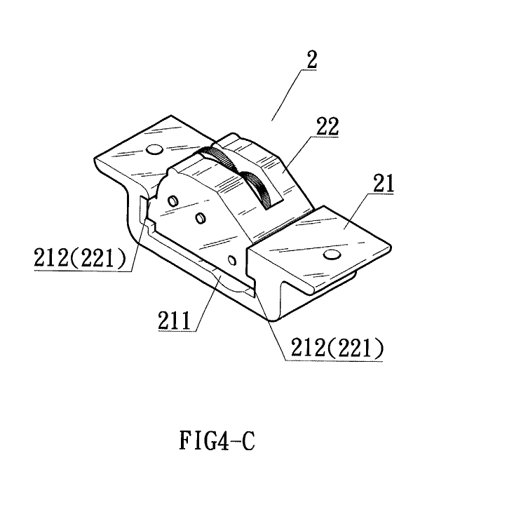

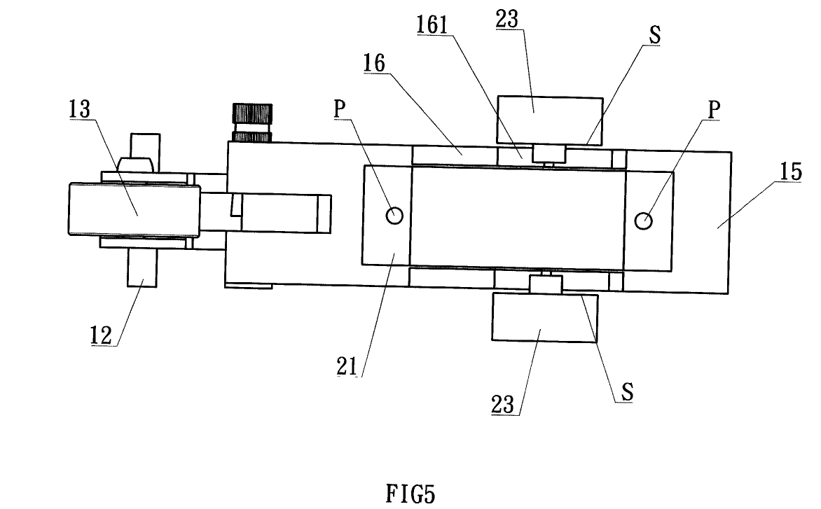

Referring to FIG. 4-A, FIG. 4-B, and FIG. 4-C, the drawings demonstrating the assembly of the invention herein, after the said gyration force mount 22 is inserted into the carrier mount 21, the turning wheels 23 at the two sides of the gyration force mount 22 are positionally fixed over the holding section 211 with a space S (as shown in FIG. 5) left between each turning wheel 23 and lateral end of the holding section 211 that provides for a slight degree leftward and rightward movement of the gyration force mount 22 on the carrier mount 21 to thereby prevent the lock-up of the gyration force mount 22 and the carrier mount 21 during the execution of turns that would adversely affect the coasting of the toy scooter; the said toy scooter has an internally installed gyration gear unit 2 capable of storing motive force during backward displacement such that following grip release, the body 1 is driven forward by inertial spinning and, as such, provides the user a toy scooter gyration force axle assembly structure having both decorative profiling and toy performance.

1. A toy scooter gyration force axle assembly structure comprised of a scooter body having a front wheel and a chassis as well as a gyration force gear unit fastened to the lower end of the said body, of which:
The said body has a lateral retaining edge extending downward from each of the two sides of its bottom end and, furthermore, an access opening is formed in the said lateral retaining edge to accommodate the insertion and positioning of the said gyration force gear unit.
The said gyration force gear unit consists of a carrier mount that is fastened to the lower extent of the said body chassis and a gyration force mount that is inserted into the said carrier mount; a holding section is disposed as a recess in the center portion, and, furthermore, a mortise is formed in each of the two sides of the said holding section such that the said tenon formed on each of the two sides of the said gyration force mount can be inserted and positioned.
After the said gyration force mount is inserted into the said carrier mount, the turning wheels at the two sides of the said gyration force mount are positionally fixed over the said holding section and, furthermore, a space is left between each said turning wheel and lateral end of the said holding section that prevents the lock-up of the said gyration force mount and the said carrier mount during the execution of turns.
As such, the present invention provides the user a toy scooter gyration force axle assembly structure having both decorative profiling and toy performance.

2. As mentioned in claim 1 of the toy scooter gyration force axle assembly structure of the invention herein, the said body has a locating vault of a moderately concave contour formed in the bottom surface of its said chassis to limit the forward and rearward movement of the said gyration force gear unit.
